(19) United States
(12) Patent Application Publication
(10) Pub. No.: US 2021/0297546 A1
(43) Pub. Date: Sep. 23, 2021

(54) DATA SECURITY SCANNER FOR DETECTING CONFIDENTIAL DATA

(71) Applicant: Capital One Services, LLC, McLean, VA (US)

(72) Inventors: Kathleen P. ROMERO, Glen Allen, VA (US); Michael Winfield RAYMOND, Doswell, VA (US)

(73) Assignee: Capital One Services, LLC, McLean, VA (US)

(21) Appl. No.: 16/821,090

(22) Filed: Mar. 17, 2020

(51) Int. Cl. H04N 1/00; G06F 21/60; G06F 3/12

(52) U.S. Cl. CPC H04N 1/00859; G06F 21/608; G06F 3/1204; G06F 3/1238; G06F 3/1255; G06F 3/1222

(57) ABSTRACT

A system and method of operating a data security scanner including: a control unit configured to: examine a document to detect an instance of confidential data, generate an alert based on finding the instance of confidential data, initiate a verification process based on generating the alert, wherein the verification process fulfills the print request by comparing a print parameter of the print request with a release condition to determine whether the release condition is satisfied, determine whether to send the document for printing based on whether the release condition is satisfied; and a communication unit, coupled to the control unit, configured to: receive the print request, and send the document for printing on a printer if the release condition is satisfied.

### TECHNICAL FIELD

An embodiment of the present disclosure relates generally to a data security scanner, and more particularly to a data security scanner for detecting confidential data.

### BACKGROUND

Data breaches are becoming ever more prevalent in today's technology and data centric world. Often, data breaches result in significant financial and reputational loss for institutions that they affect. As a result, the ability to detect and secure confidential data has become increasingly important. Despite technological advancements, current technologies still lack the ability to adequately detect and secure confidential data to mitigate data breaches. Accordingly, there remains a need for improved techniques for detecting and securing confidential data.

In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

### SUMMARY

An embodiment of the present disclosure provides a method of operating a data security scanner including: receiving, by one or more computing devices, a print request to print a document on a printer; examining, by the one or more computing devices, the document to detect an instance of confidential data; generating, by the one or more computing devices, an alert based on finding the instance of confidential data; initiating, by the one or more computing devices, a verification process based on generating the alert, wherein the verification process fulfills the print request by comparing a print parameter of the print request with a release condition to determine whether the release condition is satisfied;

determining, by the one or more computing devices, whether to send the document for printing based on whether the release condition is satisfied; and sending, by the one or more computing devices, the document for printing if the release condition is satisfied.

An embodiment of the present disclosure provides a non-transitory computer readable medium including instructions for operating a data security scanner including: receiving a print request to print a document on a printer; examining the document, using a processor, to detect an instance of confidential data; generating an alert based on finding the instance of confidential data; initiating a verification process based on generating the alert, wherein the verification process fulfills the print request by comparing a print parameter of the print request with a release condition to determine whether the release condition is satisfied; determining whether to send the document for printing based on whether the release condition is satisfied; and sending the document for printing if the release condition is satisfied.

An embodiment of the present disclosure provides a data security scanner including: a control unit configured to: examine a document to detect an instance of confidential data, generate an alert based on finding the instance of confidential data, initiate a verification process based on generating the alert, wherein the verification process fulfills the print request by comparing a print parameter of the print request with a release condition to determine whether the release condition is satisfied, determine whether to send the document for printing based on whether the release condition is satisfied; and a communication unit, coupled to the control unit, configured to: receive the print request, and send the document for printing on a printer if the release condition is satisfied.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the pertinent art to make and use the invention.

FIG. 1 is an example system in which a data security scanner for detecting confidential data operates according to an embodiment.

FIG. 2 is an example block diagram of the components of the system according to an embodiment.

FIG. 3 is an example control flow of the data security scanner according to an embodiment.

FIG. 4 is an example method of operating the data security scanner according to an embodiment.

FIG. 5 is an example computer system for implementing various embodiments.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of embodiments. However, it will be apparent that embodiments may be practiced without these specific details. In order to avoid obscuring an embodiment, some well-known circuits, system configurations, and process steps are not disclosed in detail.

The drawings showing embodiments of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the system can be operated in any orientation.

Certain embodiments have other steps or elements in addition to or in place of those mentioned. The steps or elements will become apparent to those skilled in the art from a reading of the following detailed description when taken with reference to the accompanying drawings.

The term “module” or “unit” referred to herein can include software, hardware, or a combination thereof in an embodiment of the present invention in accordance with the context in which the term is used. For example, the software can be machine code, firmware, embedded code, or application software. Also for example, the hardware can be circuitry, a processor, a special purpose computer, an integrated circuit, integrated circuit cores, a pressure sensor, an inertial sensor, a microelectromechanical system (MEMS), passive devices, or a combination thereof. Further, if a module or unit is written in the system or apparatus claims section below, the module or unit is deemed to include hardware circuitry for the purposes and the scope of the system or apparatus claims.

The modules and units in the following description of the embodiments can be coupled to one another as described or as shown. The coupling can be direct or indirect, without or with intervening items between coupled modules or units. The coupling can be by physical contact or by communication between modules or units.

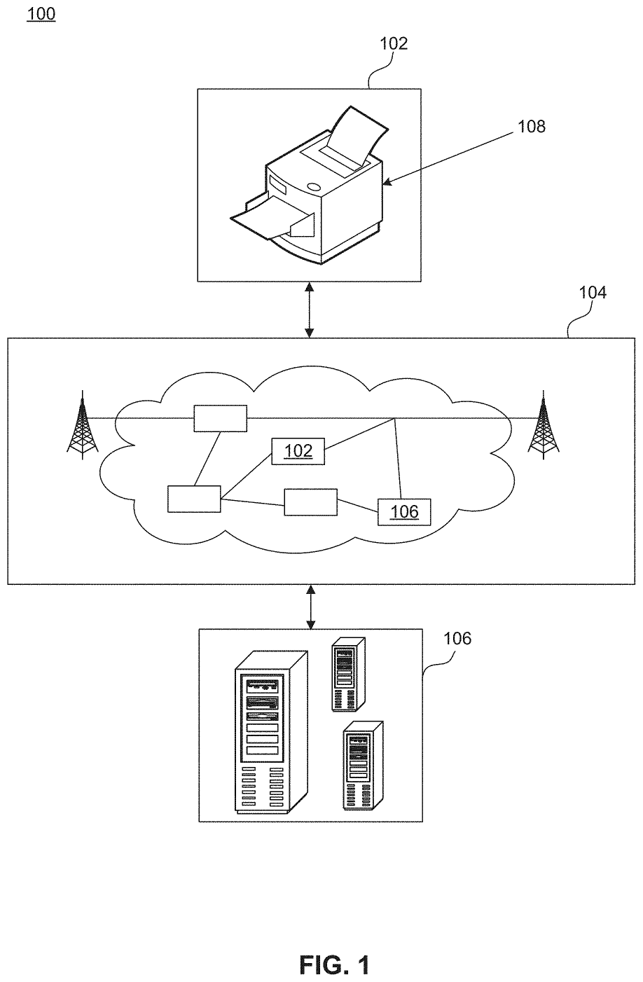

Referring now to FIG. 1, therein is shown an example system 100 in which a data security scanner for detecting confidential data operates according to an embodiment. The data security scanner refers to a device, module, unit, or combination thereof designed to detect confidential data in computer files. Confidential data refers to data or information that should not be obtained by any person or entity without permission from either the owner of the confidential data or the custodian of the confidential data. For example, confidential data can include a social security number, phone numbers, driver license numbers, bank account numbers, tax information, passwords or passphrases, employee identification numbers, information subject to trade secret protection, or a combination thereof. The aforementioned are merely exemplary and not meant to be limiting examples of confidential data.

In one embodiment, the data security scanner can control access to computer files. For example, the data security scanner can determine whether a computer files that contain confidential data should be printed on a printer 108, when such a request is made by a user of the system 100, a computer program, or a combination thereof. The data security scanner can be implemented as software, hardware, or a combination thereof, and in one embodiment can further be incorporated in a device, such as a printer 108, a server, a personal computer, a laptop computer, or a combination thereof. Operation of the data security scanner will be discussed further below.

In one embodiment, the system 100 can include a first device 102, such as a client device or a server, connected to a second device 106, such as a client device or server. The first device 102 and the second device 106 can communicate with each other through a communication path 104, such as a wireless or wired network.

For example, the first device 102 can be of any of a variety of devices, such as a smart phone, a cellular phone, a personal digital assistant, a tablet computer, a notebook computer, a laptop computer, a desktop computer, or the printer 108 with functionality including the functionality to print documents, send or receive faxes, make copies, scan documents, or a combination thereof. The first device 102 can couple, either directly or indirectly, to the communication path 104 to communicate with the second device 106 or can be a stand-alone device.

The second device 106 can be any of a variety of centralized or decentralized computing devices. For example, the second device 106 can be a laptop computer, a desktop computer, grid-computing resources, a virtualized computing resource, cloud computing resources, routers, switches, peer-to-peer distributed computing devices, a server such as a print server, a server farm, or a combination thereof. The second device 106 can be centralized in a single room, distributed across different rooms, distributed across different geographical locations, or embedded within a telecommunications network. The second device 106 can couple with the communication path 104 to communicate with the first device 102.

For illustrative purposes, the system 100 is shown with the first device 102 as a client device, although it is understood that the system 100 can have the first device 102 as a different type of device. For example, the first device 102 can be a server. Also for illustrative purposes, the system 100 is shown with the second device 106 as a server, although it is understood that the system 100 can have the second device 106 as a different type of device. For example, the second device 106 can be a client device.

For brevity of description in the embodiments discussed below, the first device 102 will be described as a client device and the second device 106 will be described as a server device. The embodiments disclosed herein, however, are not limited to this selection for the type of devices. The selection is an example of an embodiment.

Also for illustrative purposes, the system 100 is shown with the first device 102 and the second device 106 as end points of the communication path 104, although it is understood that the system 100 can have a different partition between the first device 102, the second device 106, and the communication path 104. For example, the first device 102 and the second device 106 can also function as part of the communication path 104.

The communication path 104 can span and represent a variety of networks and network topologies. For example, the communication path 104 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Cable, Ethernet, digital subscriber line (DSL), fiber optic lines, fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

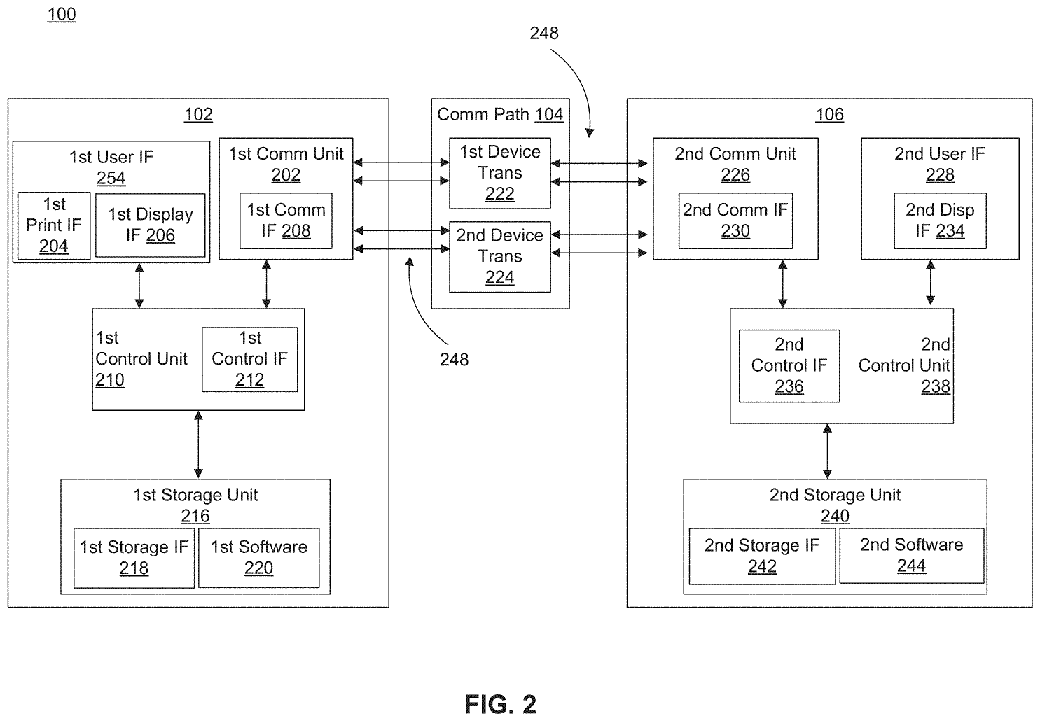

Referring now to FIG. 2, therein is shown an example block diagram of the components of the system 100 according to an embodiment. The first device 102 can send information in a first device transmission 222 over the communication path 104 to the second device 106. The second device 106 can send information in a second device transmission 224 over the communication path 104 to the first device 102. The first device transmission 222 and the second device transmission 224 can be sent over one or more communication channels 248. A communication channel 248 refers either to a physical transmission medium such as a wire, or to a logical connection over a multiplexed medium such as a radio channel.

For illustrative purposes, the system 100 is shown with the first device 102 as a client device, although it is understood that the system 100 can have the first device 102 as a different type of device. For example, the first device 102 can be a server. Also for illustrative purposes, the system 100 is shown with the second device 106 as a server, although it is understood that the system 100 can have the second device 106 as a different type of device. For example, the second device 106 can be a client device. For brevity of description in this embodiment, the first device 102 will be described as a client device and the second device 106 will be described as a server device. Embodiments are not limited to this selection for the type of devices. The selection is an example of an embodiment.

In one embodiment, the first device 102 can include a first control unit 210, a first storage unit 216, a first communication unit 202, and a first user interface 254. The first control unit 210 can include a first control interface 212. The first control unit 210 can execute a first software 220 to provide some or all of the intelligence of the system 100. The first control unit 210 can be implemented in a number of different ways. For example, the first control unit 210 can be a processor, an application specific integrated circuit (ASIC), an embedded processor, a microprocessor, a hardware control logic, a hardware finite state machine (FSM), a digital signal processor (DSP), a field programmable gate array (FPGA), or a combination thereof.

The first control interface 212 can be used for communication between the first control unit 210 and other functional units in the first device 102. The first control interface 212 can also be used for communication that is external to the first device 102. The first control interface 212 can receive information from the other functional units of the first device 102 or from external sources, or can transmit information to the other functional units of the first device 102 or to external destinations. The external sources and the external destinations refer to sources and destinations external to the first device 102. The first control interface 212 can be implemented in different ways and can include different implementations depending on which functional units or external units are being interfaced with the first control unit 210. For example, the first control interface 212 can be implemented with a pressure sensor, an inertial sensor, a microelectromechanical system (MEMS), optical circuitry, waveguides, wireless circuitry, wireline circuitry such as a bus, an application programming interface, or a combination thereof.

The first storage unit 216 can store the first software 220. For illustrative purposes, the first storage unit 216 is shown as a single element, although it is understood that the first storage unit 216 can be a distribution of storage elements. Also for illustrative purposes, the system 100 is shown with the first storage unit 216 as a single hierarchy storage system, although it is understood that the system 100 can have the first storage unit 216 in a different configuration. For example, the first storage unit 216 can be formed with different storage technologies forming a memory hierarchal system including different levels of caching, main memory, rotating media, or off-line storage. The first storage unit 216 can be a volatile memory, a nonvolatile memory, an internal memory, an external memory, or a combination thereof. For example, the first storage unit 216 can be a nonvolatile storage such as non-volatile random access memory (NVRAM), Flash memory, disk storage, or a volatile storage such as static random access memory (SRAM) or dynamic random access memory (DRAM).

The first storage unit 216 can include a first storage interface 218. The first storage interface 218 can be used for communication between the first storage unit 216 and other functional units in the first device 102. The first storage interface 218 can also be used for communication that is external to the first device 102. The first storage interface 218 can receive information from the other functional units of the first device 102 or from external sources, or can transmit information to the other functional units or to external destinations. The first storage interface 218 can include different implementations depending on which functional units or external units are being interfaced with the first storage unit 216. The first storage interface 218 can be implemented with technologies and techniques similar to the implementation of the first control interface 212.

The first communication unit 202 can enable external communication to and from the first device 102. For example, the first communication unit 202 can permit the first device 102 to communicate with the second device 106, an attachment, such as a peripheral device, and the communication path 104. The first communication unit 202 can also function as a communication hub allowing the first device 102 to function as part of the communication path 104 and not be limited to be an end point or terminal unit to the communication path 104. The first communication unit 202 can include active and passive components, such as microelectronics or an antenna, for interaction with the communication path 104.

The first communication unit 202 can include a first communication interface 208. The first communication interface 208 can be used for communication between the first communication unit 202 and other functional units of the first device 102. The first communication interface 208 can receive information from the other functional units of the first device 102 or from external sources, or can transmit information to the other functional units or to external destinations. The first communication interface 208 can include different implementations depending on which functional units are being interfaced with the first communication unit 202. The first communication interface 208 can be implemented with technologies and techniques similar to the implementation of the first control interface 212.

The first communication unit 202 can couple with the communication path 104 to send information to the second device 106 in the first device transmission 222. The second device 106 can receive information in a second communication unit 226 from the first device 102 in the first device transmission 222 through the communication path 104.

The first user interface 254 can present information generated by the system 100. In one embodiment, the first user interface 254 allows a user of the system 100 to interface with the first device 102. The first user interface 254 can include an input device and an output device. Examples of the input device of the first user interface 254 can include a keypad, buttons, switches, touchpads, soft-keys, a keyboard, or any combination thereof to provide data and communication inputs. Examples of the output device can include a first display interface 206 and a first printer interface 204. The first control unit 210 can operate the first user interface 254 to present information generated by the system 100. The first control unit 210 can also execute the first software 220 to present information generated by the system 100, or to control other functional units of the system 100.

The first display interface 206 can be any graphical user interface such as a display, a projector, a video screen, or any combination thereof. The first printer interface 204 can include components that enable printing of documents including a printer tray, a carriage unit to which ink cartridges attach, ink cartridge fixing levers, motors, circuits, paper discharge rollers, or a combination thereof. The first display interface 206 and the first printer interface 204 allow a user of the system 100 to interact with the system 100.

The second device 106 can be optimized for implementing an embodiment in a multiple device embodiment with the first device 102. In one embodiment, the second device 106 can provide additional or higher performance processing power compared to the first device 102. In one embodiment, the second device 106 can include a second control unit 238, a second storage unit 240, a second communication unit 226, and a second user interface 228.

The second control unit 238 can include a second control interface 236. The second control unit 238 can execute a second software 244 to provide some or all of the intelligence of the system 100. The second software 244 can operate independently or in conjunction with the first software 220. In one embodiment, the second control unit 238 can provide additional performance compared to the first control unit 210. The second control unit 238 can be implemented in a number of different ways. For example, the second control unit 238 can be a processor, an application specific integrated circuit (ASIC), an embedded processor, a microprocessor, a hardware control logic, a hardware finite state machine (FSM), a digital signal processor (DSP), a field programmable gate array (FPGA), or a combination thereof.

The second control unit 238 can include a second control interface 236. The second control interface 236 can be used for communication between the second control unit 238 and other functional units of the second device 106. The second control interface 236 can also be used for communication that is external to the second device 106. The second control interface 236 can receive information from the other functional units of the second device 106 or from external sources, or can transmit information to the other functional units of the second device 106 or to external destinations. The external sources and the external destinations refer to sources and destinations external to the second device 106. The second control interface 236 can be implemented in different ways and can include different implementations depending on which functional units or external units are being interfaced with the second control unit 238. For example, the second control interface 236 can be implemented with a pressure sensor, an inertial sensor, a microelectromechanical system (MEMS), optical circuitry, waveguides, wireless circuitry, wireline circuitry such as a bus, an application programming interface, or a combination thereof.

The second storage unit 240 can store the second software 244. The second storage unit 240 can be sized to provide the additional storage capacity to supplement the first storage unit 216. For illustrative purposes, the second storage unit 240 is shown as a single element, although it is understood that the second storage unit 240 can be a distribution of storage elements. Also for illustrative purposes, the system 100 is shown with the second storage unit 240 as a single hierarchy storage system, although it is understood that the system 100 can have the second storage unit 240 in a different configuration. For example, the second storage unit 240 can be formed with different storage technologies forming a memory hierarchal system including different levels of caching, main memory, rotating media, or off-line storage. The second storage unit 240 can be a volatile memory, a nonvolatile memory, an internal memory, an external memory, or a combination thereof. For example, the second storage unit 240 can be a nonvolatile storage such as non-volatile random access memory (NVRAM), Flash memory, disk storage, or a volatile storage such as static random access memory (SRAM) or dynamic random access memory (DRAM).

The second storage unit 240 can include a second storage interface 242. The second storage interface 242 can be used for communication between the second storage unit 240 and other functional units of the second device 106. The second storage interface 242 can also be used for communication that is external to the second device 106. The second storage interface 242 can receive information from the other functional units of the second device 106 or from external sources, or can transmit information to the other functional units or to external destinations. The second storage interface 242 can include different implementations depending on which functional units or external units are being interfaced with the second storage unit 240. The second storage interface 242 can be implemented with technologies and techniques similar to the implementation of the second control interface 236.

The second communication unit 226 can enable external communication to and from the second device 106. For example, the second communication unit 226 can permit the second device 106 to communicate with the first device 102, an attachment, such as a peripheral device, and the communication path 104. The second communication unit 226 can also function as a communication hub allowing the second device 106 to function as part of the communication path 104 and not be limited to be an end point or terminal unit to the communication path 104. The second communication unit 226 can include active and passive components, such as microelectronics or an antenna, for interaction with the communication path 104.

The second communication unit 226 can couple with the communication path 104 to send information to the first device 102 in the second device transmission 224. The first device 102 can receive information in a first communication unit 202 from the second device 106 in the second device transmission 224 through the communication path 104.

The second communication unit 226 can include a second communication interface 230. The second communication interface 230 can be used for communication between the second communication unit 226 and other functional units of the second device 106. The second communication interface 230 can receive information from the other functional units of the second device 106 or from external sources, or can transmit information to the other functional units or to external destinations. The second communication interface 230 can include different implementations depending on which functional units are being interfaced with the second communication unit 226. The second communication interface 230 can be implemented with technologies and techniques similar to the implementation of the second control interface 236.

The second user interface 228 can present information generated by the system 100. In one embodiment, the second user interface 228 allows a user of the system 100 to interface with the second device 106. The second user interface 228 can include an input device and an output device. Examples of the input device of the second user interface 228 can include a keypad, buttons, switches, touchpads, soft-keys, a keyboard, or any combination thereof to provide data and communication inputs. Examples of the output device can include a second display interface 234. The second control unit 238 can operate the second user interface 228 to present information generated by the system 100. The second control unit 238 can also execute the second software 244 to present information generated by the system 100, or to control other functional units of the system 100.

The second display interface 234 can be any graphical user interface such as a display, a projector, a video screen, or any combination thereof. The second display interface 234 allows a user of the system 100 to interact with the system 100.

Functionality of the system 100 can be provided by the first control unit 210, the second control unit 238, or a combination thereof. For illustrative purposes, the second device 106 is shown with the partition having the second user interface 228, the second storage unit 240, the second control unit 238, and the second communication unit 226, although it is understood that the second device 106 can have a different partition. For example, the second software 244 can be partitioned differently such that some or all of its function can be in the second control unit 238 and the second communication unit 226. Also, the second device 106 can include other functional units not shown in FIG. 2 for clarity.

The first device 102 can have a similar or different partition as the second device 106. The functional units in the first device 102 can work individually and independently of the other functional units. The first device 102 can work individually and independently from the second device 106 and the communication path 104. The functional units in the second device 106 can work individually and independently of the other functional units. The second device 106 can work individually and independently from the first device 102 and the communication path 104.

For illustrative purposes, the system 100 is described by operation of the first device 102 and the second device 106. It is understood that the first device 102 and the second device 106 can operate any of the modules, units, and functions of the system 100.

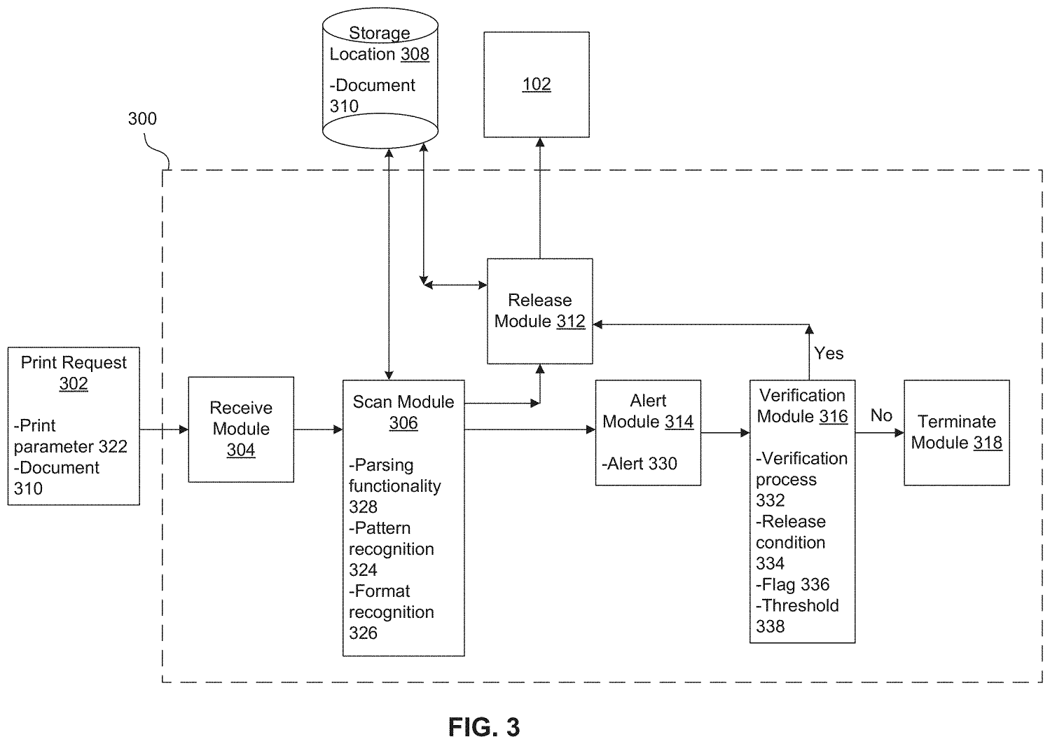

Referring now to FIG. 3, therein is shown an example control flow 300 of the data security scanner according to an embodiment. For brevity of description, the control flow 300 in FIG. 3 will be described as functioning on the second device 106, for example a server such as a print server. However, this is merely an exemplary embodiment. In another embodiment, the control flow 300 can function on the first device 102.

In one embodiment, the control flow 300 can be implemented with modules and sub-modules. In one embodiment, the control flow 300 can include a receive module 304, a scan module 306, a release module 312, an alert module 314, a verification module 316, and a terminate module 318. In one embodiment, the receive module 304 can couple to the scan module 306. The scan module 306 can couple to the release module 312 and the alert module 314. The alert module 314 can couple to the verification module 316. The verification module 316 can couple to the terminate module 318 and the release module 312.

The receive module 304 can enable the receipt of a print request 302 to print a document 310 on the first device 102, for example the printer 108 of FIG. 1. The document 310 can be a computer file such as a text file, spreadsheet, portable document format (PDF) document, or a combination thereof that can be printed on the first device 102. In one embodiment, the document 310 can be provided with the print request 302 as an attachment or an embedded file. In another embodiment, the print request 302 can include a file location or file address as a print parameter 322 of the print request 302, indicating where the document 310 is stored or saved on a storage location 308, such that the data security scanner can access the document 310 from the storage location 308. The storage location 308 can be, for example, the first storage unit 216, the second storage unit 240, or an external storage external to the first device 102 or the second device 106. In one embodiment, the storage location 308 can be a file repository or file server. In one embodiment, the receive module 304 can receive the print request 302 from a user of the system 100 using a further device (not shown), such as a mobile device, a laptop computer, a desktop computer, or a tablet computer. In another embodiment, the receive module 304 can receive the print request 302 from a computer program, without a direct request of the user of the system 100.

In one embodiment, the print request 302 can include the print parameter 322. The print parameter 322 refers to a value, variable, parameter, data structure, or a combination thereof indicating information about the print request 302, the document 310, or a combination thereof. For example, the print parameter 322 can include a user name or a user identification number of the user of the system 100 making the print request 302, the name and address of the computer program making the print request 302, a location information indicating the physical location where the print request 302 is coming from, a device information identifying the device the document 310 is to be printed on, a device information indicating the device making the print request 302, a time stamp information indicating when the print request 302 was made, or the file location or file address indicating where the document 310 is stored or saved. The aforementioned are merely exemplary and not meant to be limiting of a particular print parameter 322. In one embodiment, the print parameter 322 can be used to determine whether to fulfill the print request 302. The manner in which the print parameter 322 can be used to determine whether to fulfill the print request 302 will be discussed further below.

Continuing with the example, once the print request 302 is received by the receive module 304, the receive module 304 can pass control, the print parameter 322, and optionally the document 310 to the scan module 306. The scan module 306 can enable examination of the document 310 to detect whether the document 310 contains an instance of confidential data. The scan module 306 can enable examination of the document 310 directly via receiving the document 310 directly from the receive module 304, or can enable examination of the document 310 by accessing the document 310 from a file location or file address on the storage location 308 received via the print parameter 322.

The scan module 306 can enable examination of the document 310 in a variety of ways. For example, in one embodiment, the scan module 306 can implement a parsing functionality 328 to examine metadata of the document 310 to detect whether the document 310 contains an instance of confidential data. In one embodiment, the scan module 306 can further implement a pattern recognition functionality 324 to examine the document 310 for a pattern or sequence of text, numbers, or a combination thereof indicating an instance of confidential data. In one embodiment, the scan module 306 can further implement a format recognition functionality 326 to examine the document 310 for a format indicating that the document 310 contains an instance of confidential data.

In one embodiment, the parsing functionality 328 can search for tags, keywords, text, numbers, number strings, codes, or a combination thereof, in the document body or the metadata of the document 310 and determine, based on the tags, keywords, text, numbers, number strings, codes, or a combination thereof, that the document 310 contains an instance of confidential data. As an example, if the metadata contains a tag, associated with a confidential data, for example, a tag such as “SOCIAL SECURITY NUMBER” indicating a social security number, “ACCOUNT NUMBER” indicating an account number, or another tag associated with an instance of confidential data, the scan module 306 can, after parsing the metadata and recognizing the tag, determine that the document 310 contains an instance of confidential data. In another embodiment, if the body of the document 310 contains text such as a social security number, an account number, or other text indicating a confidential data, the scan module 306 can, after parsing the body of the document 310 and recognizing the text, determine that the document 310 contains an instance of confidential data. In one embodiment, the scan module 306 can be pre-programmed to recognize the tags, keywords, text, numbers, number strings, codes, or a combination thereof. For example, the tags, keywords, text, numbers, number strings, codes or a combination thereof, can be pre-determined and saved in the storage location 308 such that the scan module 306 can look for the specific tags, keywords, text, numbers, number strings, codes or a combination thereof, when parsing the metadata or the body of the document 310. In one embodiment, once it is determined that the document 310 contains an instance of confidential data, the document 310 can be sent to one or more further modules of the system 100 for further processing to determine whether it should be printed.

In one embodiment, the pattern recognition functionality 324 can be implemented to recognize sequences of keywords, text, numbers, number strings, or a combination thereof, and determine based on the sequences that the document 310 contains an instance of confidential data. The pattern recognition functionality 324 can be implemented in a variety of ways. For example, in one embodiment, the pattern recognition functionality 324 can be implemented using a machine learning process such as a neural network, a convolutional neural network, or other machine learning processes, wherein the machine learning processes can be trained to recognize patterns, such as the sequences of keywords, text, numbers, number strings, or a combination thereof, and based on recognizing the patterns, can determine that the document 310 contains an instance of confidential data. As an example, certain sequences of headers can be used in particular documents containing confidential data, such as bank statements, account statements, or similar documents. For example, the headers can be in an order, for example “OVERVIEW,” “BALANCE,” “TRANSACTIONS,” and “SUMMARY.” In one embodiment, the machine learning process can be trained to recognize the particular sequence of headers such that whenever the particular sequence of headers is recognized, the scan module 306 can determine that the document 310 is a certain type of document, such as a bank statement or an account statement, and can determine that the document 310 contains an instance of confidential data as a result of its categorization. In one embodiment, once it is determined that the document 310 contains an instance of confidential data the document 310 can be sent to one or more further modules of the system 100 for further processing to determine whether it should be printed.

In one embodiment, the format recognition functionality 326 can be implemented to recognize a particular document format indicating an instance of confidential data. In one embodiment, recognizing the document format includes recognizing the physical layout of text, images, or a combination thereof of the document 310 and determining based on the layout whether the document 310 contains an instance of confidential data. Similar to the pattern recognition functionality 324, the format recognition functionality 326 can be implemented using a machine learning process such as a neural network, a convolutional neural network, or other machine learning processes, wherein the machine learning processes are trained to recognize the format of the document 310, by for example extracting one or more features, such as curves, peaks, valleys, shapes, lines, or colors, or a combination thereof such that the document 310 can be categorized as a particular type of document, for example, a bank statement, an account statement, or other similar documents that contain an instance of confidential data. Based on the categorization, the scan module 306 can determine whether the document 310 contains an instance of confidential data. As an example, if bank statements are formatted in a particular manner, such as having a particular table or chart placed in a specific and known location, the format recognition functionality 326 can implement a machine learning process trained to recognize that particular format, and upon detecting a document 310 with that particular format can determine that the document 310 is a certain type of document, such as a bank statement, an account statement, or a similar document that contains an instance of confidential data. In one embodiment, once it is determined that the document 310 contains an instance of confidential data the document 310 can be sent to one or more further modules of the system 100 for further processing to determine whether it should be printed.

In one embodiment, if after implementing the parsing functionality 328, the pattern recognition functionality 324, the format recognition functionality 326, or a combination thereof, the scan module 306 determines that the document 310 does not contain an instance of confidential data, the scan module 306 can pass control, the print parameter 322, and optionally the document 310 to the release module 312. The release module 312 can enable the sending, and optionally the retrieval, of the document 310 for printing on a device, for example, the first device 102 of FIG. 1. In one embodiment, where the document 310 is passed directly to the release module 312, the release module 312 can send the document 310 to the first device 102 on which the document 310 can be printed. In another embodiment, where the document 310 itself is not passed to the release module 312 but the file location or file address of the document 310 is passed to the release module 312, the release module 312 can retrieve the document 310 from the storage location 308 and can further send the document 310 to the first device 102 for printing.

Continuing with the example, in one embodiment, if after implementing the parsing functionality 328, the pattern recognition functionality 324, the format recognition functionality 326, or a combination thereof, the scan module 306 determines that the document 310 contains an instance of confidential data, the scan module 306 can pass control, the print parameter 322, and optionally the document 310 to the alert module 314. The alert module 314 enables the generation of an alert 330 based on the scan module 306 detecting an instance of confidential data in the document 310. The alert 330 refers to a value, variable, parameter, data structure, or a combination thereof used to indicate that the document 310 contains an instance of confidential data. The alert 330 can be a numerical value, a textual value, or a combination thereof. For example, in one embodiment, the alert 330 can be a binary value such as a “1,” “0,” “YES,” or “NO” value. In another embodiment, the alert 330 can be a string of text such as “CONTAINS CONFIDENTIAL DATA” or “DOES NOT CONTAIN CONFIDENTIAL DATA.” In one embodiment, the system 100 can associate the alert 330 with the document 310, the print request 302, or a combination thereof by for example linking the alert 330 to the document 310, the print request 302, or a combination thereof, as a further print parameter 322 of the print request 302, such that the other modules of the system 100 will know that the print request 302 is for a document 310 that contains an instance of confidential data and that printing of the document 310 will require additional verification steps. The verification steps will be discussed further below.

In one embodiment, once the alert module 314 generates the alert 330 and associates the alert 330 with the print request 302, the document 310, or a combination thereof, the alert module 314 can pass control, the print parameter 322, and optionally the document 310 to the verification module 316. The verification module 316 enables a verification process 332 used to determine whether to fulfill the print request 302 and print the document 310. The verification process 332 refers to a series of checks or tests that need to be passed or satisfied before the print request 302 is fulfilled and the document 310 is sent for printing on the first device 102. In one embodiment, the verification process 332 can be implemented using the print parameter 322 and a release condition 334, wherein the print parameter 322 is compared to the release condition 334 to determine whether to fulfill the print request 302 and to print the document 310.

The release condition 334 refers to a rule or series of rules, that must be satisfied in order for the print request 302 to be fulfilled. By way of example, in one embodiment, the release condition 334 can include a rule or series of rules indicating who can print documents containing an instance of confidential data, from where a print request 302 for documents containing an instance of confidential data can originate, at what times a print request 302 for documents containing an instance of confidential data can be made, from what device a print request 302 for documents containing an instance of confidential data can be made, to what device documents containing an instance of confidential data can be printed, or a combination thereof. In one embodiment, the verification module 316 can compare the print parameter 322 to the release condition 334 and determine whether the print parameter 322 satisfies the rules or series of rules imposed by the release condition 334. For example, in one embodiment, if the print request 302 is made by a user of the system 100 authorized to make the print request 302, or if the print request 302 is made from a device authorized to make the print request, or a combination thereof, the verification module 316 can determine that the rule or series of rules imposed by the release condition 334 is satisfied and can generate a flag 336 indicating that the release condition 334 is satisfied and that the document 310 can be release for printing on the first device 102.

The flag 336 refers to a value, variable, parameter, data structure, or a combination thereof used to indicate that the release condition 334 is satisfied. In one embodiment, the flag can be a numerical value, a textual value, or a combination thereof. For example, in one embodiment, the flag 336 can be a binary value such as a “1,” “0,” “YES,” or “NO” value, where a value of “1” or “YES” indicates that the release condition 334 is satisfied and the value of “0” or “NO” indicates that the release condition 334 is not satisfied.

In one embodiment, where more than one release condition 334 is used as a part of the verification process 332, the verification module 316 can further implement a threshold 338 such that the flag 336 is not generated until the threshold 338 is satisfied. The threshold 338 refers to a value indicating a minimum number of release conditions that must be satisfied before the flag 336 is generated. The threshold 338 can be represented as a percentage, an absolute value, or a combination thereof. For example, the threshold 338 can be set to a percentage, for example “90%” such that only when ninety (90) percent or more of the release conditions are satisfied, the flag 336 is generated indicating the release condition 334 is satisfied. In another embodiment, the threshold 338 can be set to an absolute value, for example “2” such that when two (2) or more release conditions are satisfied, the flag 336 is generated indicating the release condition 334 is satisfied.

Continuing with the example, in one embodiment, if, as a result of the verification process 332, the verification module 316 determines that the release condition 334 is satisfied, the verification module 316 can pass control, the print parameter 322, and optionally the document 310 to the release module 312 which can further release the document 310 for printing and enable the sending, and optionally the retrieval, of the document 310 for printing on the first device 102. If, however, as a result of the verification process 332 the verification module 316 determines that the release condition 334 is not satisfied, the verification module 316 can pass control to the terminate module 318 to end the control flow 300 and not permit the document 310 to be printed on the first device 102. In one embodiment, once the terminate module 318 terminates the control flow 300, the print request 302 can be discarded, and an error message can be generated and displayed, on for example the first display interface 206, the second display interface 234, or an external device indicating that the print request 302 could not be fulfilled.

It has been discovered that the methods, modules, units, and components implementing the above described system 100 significantly improves the ability to detect confidential data in documents because it allows the system 100 the ability to analyze documents directly, including analyzing the contents of documents when a print request 302 is made, to determine whether documents contain instances of confidential data and whether it should be printed or not. It has been further discovered that the use of machine learning processes in the above described system 100, including for example neural networks, convolutional neural networks, or other machine learning processes allows the system 100 to provide greater automation and accuracy when detecting instances of confidential data because it allows the system 100 to learn patterns, keywords, and formats over a large number of documents to recognize documents containing instances of confidential data. It has been further discovered that the use of machine learning processes in the above described system 100 significantly improves the ability to automatically recognize instances of documents that should not be printed without the need for human intervention and decision making and further allows the system 100 to process large numbers of print requests to determine whether documents should be printed or not.

It has been further discovered that the system 100 significantly improves data security for organizations because it prevents documents containing instances of confidential data from being printed to unauthorized users or unauthorized devices by implementing a rule based process which can determine what documents should or should not be printed after a document has been identified as containing an instance of confidential data. It has been further discovered that the system 100 described above significantly improves data security because it allows print requests that are unauthorized to be terminated so as to prevent unauthorized printing and distribution of documents containing instances of confidential data. It has been further discovered that the system 100 significantly improves the ability to control the level of data security measures taken by an organization because it allows the customization of thresholds needed to print documents containing instances of confidential data so as to change requirements based on organizational needs and requirements.

The system 100 has been described with module functions or order as an example. The system 100 can partition the modules differently or order the modules differently. For example, the first software 220, the second software 244, or a combination thereof can include the modules for the system 100. As a specific example, the first software 220, the second software 244, or a combination thereof can include the receive module 304, the scan module 306, the release module 312, the alert module 314, the verification module 316, the terminate module 318, and associated sub-modules included therein.

The first control unit 210, the second control unit 238, or a combination thereof, can execute the first software 220, the second software 244, or a combination thereof, to operate the modules. For example, the first control unit 210, the second control unit 238, or a combination thereof, can execute the first software 220, the second software 244, or a combination thereof, to implement the receive module 304, the scan module 306, the release module 312, the alert module 314, the verification module 316, the terminate module 318, and associated sub-modules included therein.

The modules described in this application can be implemented as instructions stored on a non-transitory computer readable medium to be executed by the first control unit 210, the second control unit 238, or a combination thereof. The non-transitory computer readable medium can include the first storage unit 216, the second storage unit 240, or a combination thereof. The non-transitory computer readable medium can include non-volatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the system 100 or installed as a removable portion of the system 100.

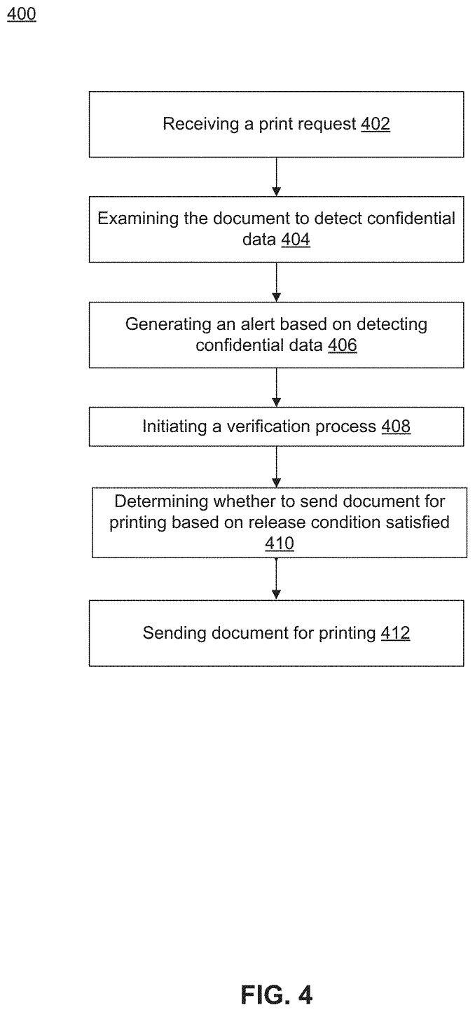

Referring now to FIG. 4, therein is shown an example method 400 of operating the data security scanner according to an embodiment. The method 400 includes: receiving, by one or more computing devices, a print request to print a document on a printer as shown in box 402; examining, by the one or more computing devices, the document to detect an instance of confidential data as shown in box 404; generating, by the one or more computing devices, an alert based on finding the instance of confidential data as shown in box 406; initiating, by the one or more computing devices, a verification process based on generating the alert, wherein the verification process fulfills the print request by comparing a print parameter of the print request with a release condition to determine whether the release condition is satisfied as shown in box 408; determining, by the one or more computing devices, whether to send the document for printing based on whether the release condition is satisfied as shown in box 410; and sending, by the one or more computing devices, the document for printing if the release condition is satisfied as shown in box 412.

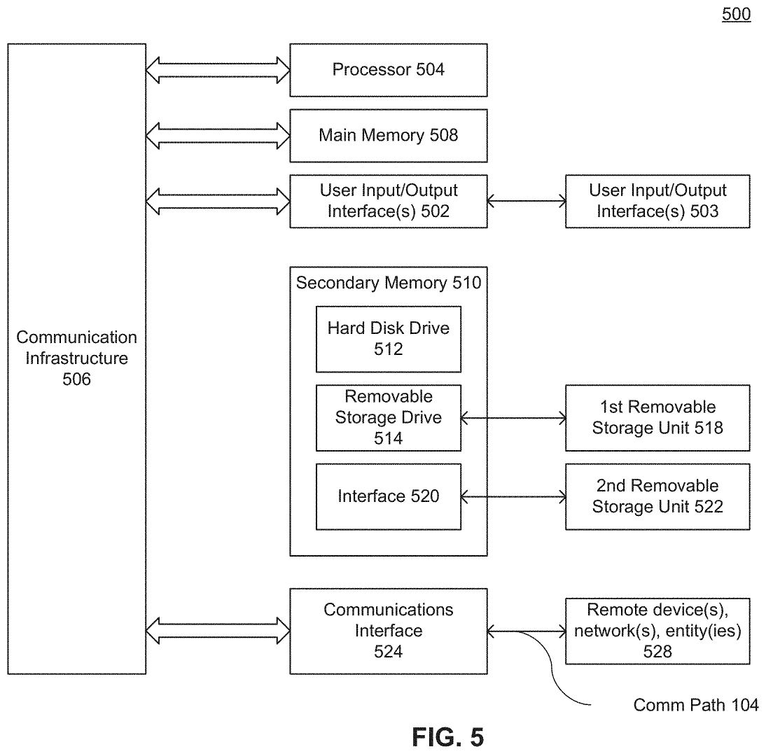

Referring now to FIG. 5, therein is shown an example computer system 500 for implementing various embodiments. Various embodiments may be implemented, for example, using one or more well-known computer systems, such as the computer system 500 shown in FIG. 5. The computer system 500 may be used, for example, to implement any of the embodiments discussed herein, as well as combinations and sub-combinations thereof.

Computer system 500 may include one or more processors, for example a processor 504. Processor 504 may be connected to a communication infrastructure or bus 506. Computer system 500 may also include user input/output device(s) 503, such as monitors, keyboards, pointing devices, etc., which may communicate with communication infrastructure 506 through user input/output interface(s) 502.

The processor 504 may be a graphics processing unit (GPU). In one embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a first removable storage unit 518. The first removable storage unit 518 may include a computer usable or readable storage device having stored thereon computer software (control logic) and/or data. The first removable storage unit 518 may be a floppy disk, magnetic tape, compact disk, DVD, optical storage disk, and/any other computer data storage device. Removable storage drive 514 may read from and/or write to the first removable storage unit 518.

Secondary memory 510 may include other means, devices, components, instrumentalities or other approaches for allowing computer programs and/or other instructions and/or data to be accessed by the computer system 500. Such means, devices, components, instrumentalities or other approaches may include, for example, a second removable storage unit 522 and an interface 520. Examples of the second removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable the computer system 500 to communicate and interact with any combination of external devices, external networks, external entities, etc. (individually and collectively referenced by reference number 528). For example, communication interface 524 may allow computer system 500 to communicate with external or remote devices 528 over the communications path 104. Control logic and/or data may be transmitted to and from the computer system 500 via the communication path 104.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in the computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, the computer system 500, main memory 508, secondary memory 510, and first and second removable storage units 518 and 522, as well as tangible articles of manufacture embodying any combination of the foregoing. Such control logic, when executed by one or more data processing devices (such as the computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

The above detailed description and embodiments of the disclosed system 100 are not intended to be exhaustive or to limit the disclosed system 100 to the precise form disclosed above. While specific examples for the system 100 are described above for illustrative purposes, various equivalent modifications are possible within the scope of the disclosed system 100, as those skilled in the relevant art will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The resulting method, process, apparatus, device, product, and system is cost-effective, highly versatile, and accurate, and can be implemented by adapting components for ready, efficient, and economical manufacturing, application, and utilization. Another aspect of an embodiment is that it valuably supports and services the historical trend of reducing costs, simplifying systems, and increasing performance.

These and other valuable aspects of the embodiments consequently further the state of the technology to at least the next level. While the disclosed embodiments have been described as the best mode of implementing the data security scanner, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A method of operating a data security scanner comprising:
receiving, by one or more computing devices, a print request to print a document on a printer;
examining, by the one or more computing devices, the document to detect an instance of confidential data;
generating, by the one or more computing devices, an alert based on finding the instance of confidential data;
initiating, by the one or more computing devices, a verification process based on generating the alert, wherein the verification process fulfills the print request by comparing a print parameter of the print request with a release condition to determine whether the release condition is satisfied;
determining, by the one or more computing devices, whether to send the document for printing based on whether the release condition is satisfied; and
sending, by the one or more computing devices, the document for printing if the release condition is satisfied.

2. The method of claim 1, wherein examining the document further includes examining a content of the document to detect the instance of confidential data.

3. The method of claim 2, wherein examining the content of the document to detect the instance of confidential data further includes examining a metadata of the document for the instance of confidential data.

4. The method of claim 2, wherein examining the content of the document to detect the instance of confidential data further includes examining the document for a pattern indicating that the instance of confidential data is present.

5. The method of claim 4, wherein examining the content of the document for the pattern includes examining a format of the document for indication of the instance of confidential data.

6. The method of claim 1, further comprising terminating the print request when determining that the release condition is not satisfied.

7. The method of claim 1, wherein fulfilling the print request is further based on a threshold, wherein the threshold represents a minimum number of release conditions that need to be satisfied before fulfilling the print request.

8. A non-transitory computer readable medium including instructions for operating a data security scanner comprising:
receiving a print request to print a document on a printer;
examining the document, using a processor, to detect an instance of confidential data;
generating an alert based on finding the instance of confidential data;
initiating a verification process based on generating the alert, wherein the verification process fulfills the print request by comparing a print parameter of the print request with a release condition to determine whether the release condition is satisfied;
determining whether to send the document for printing based on whether the release condition is satisfied; and
sending the document for printing if the release condition is satisfied.

9. The non-transitory computer readable medium of claim 8 with instructions wherein examining the document further includes examining a content of the document to detect the instance of confidential data.

10. The non-transitory computer readable medium of claim 9 with instructions wherein examining the content of the document to detect the instance of confidential data further includes examining a metadata of the document for the instance of confidential data.

11. The non-transitory computer readable medium of claim 9 with instructions wherein examining the content of the document to detect the instance of confidential data further includes examining the document for a pattern indicating that the instance of confidential data is present.

12. The method of claim 11, wherein examining the content of the document for the pattern includes examining a format of the document for indication of the instance of confidential data.

13. The non-transitory computer readable medium of claim 8 with instructions further comprising terminating the print request when determining that the release condition is not satisfied.

14. The non-transitory computer readable medium of claim 8 with instructions wherein fulfilling the print request is further based on a threshold, wherein the threshold represents a minimum number of release conditions that need to be satisfied before fulfilling the print request.

15. A data security scanner comprising:
a control unit configured to:
examine a document to detect an instance of confidential data,
generate an alert based on finding the instance of confidential data,
initiate a verification process based on generating the alert, wherein the verification process fulfills the print request by comparing a print parameter of the print request with a release condition to determine whether the release condition is satisfied,
determine whether to send the document for printing based on whether the release condition is satisfied; and
a communication unit, coupled to the control unit, configured to:
receive the print request, and
send the document for printing on a printer if the release condition is satisfied.

16. The data security scanner of claim 15, wherein the control unit is further configured to examine a content of the document to detect the instance of confidential data.

17. The data security scanner of claim 16, wherein the control unit is further configured to examine the content of the document to detect the instance of confidential data based on examining a metadata of the document for the instance of confidential data.

18. The data security scanner of claim 16, wherein the control unit is further configured to examine the content of the document to detect the instance of confidential data based on examining the content of the document for a pattern indicating that the instance of confidential data is present.

19. The data security scanner of claim 15, wherein the control unit is further configured to terminate the print request when determining that the release condition is not satisfied.

20. The data security scanner of claim 15, wherein the control unit is further configured to fulfill the print request based on a threshold, wherein the threshold represents a minimum number of release conditions that need to be satisfied before fulfilling the print request.
